(19) United States
(12) Patent Application Publication
(10) Pub. No.: US 2004/0176109 A1
(43) Pub. Date: Sep. 9, 2004

(54) Location system

(76) Inventor: Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/429,947

(22) Filed: May 6, 2003

Related U.S. Application Data
(60) Provisional application No. 60/448,535, filed on Feb. 21, 2003.

(51) Int. Cl. H04M 1/00

(52) U.S. Cl. 455/456.5

(57) ABSTRACT

An improved method for locating user equipment during handover. The user equipment is able to communicate over at least a first and a second channel. The method is performed by requesting the location of the user equipment which is communicating on the first channel. Initiating the determination of the location of the user equipment. The user equipment is handed over to communicate on the second channel. Determination of the location of the user equipment on the first channel continues until the handing over has been completed.

### CROSS REFERENCE TO RELATED APPLICATIONS

This application claims priority of U.S. Provisional Patent Application Serial No. 60/448,535, entitled “Improvements in a Location System” filed on Feb. 21, 2003, the contents of which are hereby incorporated by reference.

### BACKGROUND OF THE INVENTION

1. Field of the Invention

The present invention relates to a method and system for locating user equipment within a communications network.

2. Description of the Related Art

A cellular telecommunications system is a communication system that is based on use of radio access entities and/or wireless service areas. The access entities are typically referred to as cells. Examples of cellular telecommunications systems include standards such as the GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access), TDMA/CDMA (Time Division Multiple Access/

[symbol]

In a cellular system, a base transceiver station (BTS) provides a wireless communication facility that serves mobile stations (MS) or similar wireless user equipment (UE) via an air or radio interface within the coverage area of the cell. As the approximate size and the shape of the cell are known, it is possible to associate the cell to a geographical area. Each of the cells can be controlled by an appropriate controller apparatus.

Elements of the cellular network can be used to provide location information concerning a mobile station and the user thereof. More particularly, the cells or similar geographically limited service areas facilitate the cellular telecommunications system to produce at least a rough location information estimate concerning the current geographical location of a mobile station, as the cellular telecommunications system is aware of the cell with which a mobile station currently associates. Therefore, it is possible to conclude from the location of the cell the geographical area in which the mobile station is likely to be at a given moment. This information is also available when the mobile station is located within the coverage area of a visited or “foreign” network. The visited network may be capable of transmitting location information of the mobile station back to the home network, e.g. to support location services or for the purposes of call routing and charging.

A location service feature may be provided by a separate network element such as a location server which receives location information from at least one of the controllers of the system. If no further computations and/or approximations are made, this would give the location to an accuracy of one cell, i.e. it would indicate that the mobile station is (or at least was) within the coverage area of a certain cell.

However, more accurate information concerning the geographical location of a mobile station may be desired. For example, the United States Federal Communication Commission (FCC) has mandated that wireless service providers have to implement location technologies that can locate wireless phone users who are calling to emergency numbers. Although the FCC order is directed to emergency caller location, other commercial and non-commercial uses for mobile systems, such as fleet management, location-dependent billing, advertising and providing information or navigation applications, might also find more accurate location information useful. As an example of the estimated value of the locations service, reference can be made to a research report by the “Strategis Group” which claims that location-based services would create over USD 16 billion annual worldwide revenues by year 2005.

The accuracy of the location determination may be improved by using results of measurements which define the travel time (or travel time differences) of the radio signal sent by a mobile station to the base station. More accurate location information may be obtained through e.g. by calculating the geographical location from range or range difference (RD) measurements. All methods that use range difference (RD) measurements may also be called TDOA (time difference of arrival) methods such as mathematically RD=c*TDOA, wherein c is the signal propagation speed. Observed time difference (OTD), E-OTD (Enhanced OTD) and TOA (time of arrival) are mentioned herein as examples of technologies that are based on the RD measurements.

The difference between the TOA (time of arrival) and the E-OTD is in that in the TOA the mobile station sends the signal and the network makes the measurements, whereas in the E-OTD the network sends the signals and the mobile station measures them. The mobile stations are provided with appropriate equipment and software to provide information on which the positioning of the mobile station can be based on. The mobile station may communicate the information via the base station to an appropriate network element that may use the information in a predefined manner.

It is also possible to form RD measurements based on other sources, e.g. from GPS (Global Positioning System) pseudo-range measurements.

The measurements are accomplished by a number of base stations (preferably at least three) covering the area in which the mobile station is currently located. The measurement by each of the base stations gives the distance (range) between the base station and the mobile station or distance difference (range difference) between the mobile station and two base stations. Each of the range measurements generates a circle that is centered at the measuring base station, and the mobile station is determined to be located at an intersection of the circles. Each of the range difference measurements by two base stations creates a hyperbola (not a circle as in the range measurements). Thus, if range differences are used in the location calculation, the intersections of the hyperbolas are searched for. In an ideal case and in the absence of any measurement error, the intersection of the circles or the hyperbolas would unambiguously determine the location of the mobile station.

In principle, in the hyperbolic case two hyperbolas (i.e., measurements from three different sites), and in the circular case two circles (i.e., measurements from two different sites) are enough for location estimation. However, circles/hyperbolas can intersect twice, which means that in an ideal case, measurement from one more site is needed for an unambiguous solution unless some prior information is available which is good enough to reject the wrong solution.

As mentioned for TDOA, it is the network that is responsible for making the measurements and has LMUs (Location Measuring Units) to receive signals from the MS, and a SMLC (Serving Mobile Location Center) to calculate the location of the MS.

U-TDOA (Uplink Time Difference of Arrival) has been selected for the Emergency 911 method in the USA. The TDOA method is also going to be integrated in the GSM network by adding a new interface to the SMLC and by adding new signals to the GSM standards, for example the 3GPP TS 09.31 V8.5.0 (2001-12) GSM standard. Draft changes to the versions of the standard have already been presented in 3GPP (3^{rd} Generation Partnership Project) meetings.

However, a problem exists if the location procedure is performed during handover between channels controlled by different BSCs (Base Station Controller) or MSCs (Mobile Switching Centers). That is, at present if an inter-BSC or inter-MSC handover occurs during the location procedure, then the BSC aborts the location procedure. If the handover is unsuccessful, the location procedures need to be restarted and all earlier measurements are lost.

Moreover, handover from the serving channel to the target channel may be queued for over 10 seconds and end due to congestion, which means that over 10 seconds are lost by waiting for the target channel reservation.

Therefore, there is a need to improve the efficiency of location calculations during the handover of channels between BSCs.

### SUMMARY OF THE INVENTION

The embodiments of the present invention seek to address one or more of these problems.

One embodiment of the present invention includes a method of locating user equipment which is able to communicate over at least a first and a second channel. The method includes requesting a location of user equipment which is communicating on the first channel and initiating the determination of the location of the user equipment. The user equipment can be handed over to communicate on the second channel. The determination of the location of the user equipment on the first channel can continue until the handing over has been completed.

Another embodiment of the present invention includes a system for locating user equipment which is able to communicate over at least a first and a second channel. The system can include a location entity; and a first controller is configured to send a request to the location entity for the location of the user equipment which is communicating on the first channel. The location entity can be configured to initiate a determination of the location of the user equipment. When the user equipment is to be handed over to the second channel, the determination of the location of the user equipment on the first channel can be continued until the handing over has been completed.

In a further embodiment of the present invention a method of locating user equipment includes requesting the location of the user equipment which is controlled by a first controller and initiating the determination of the location of the user equipment. The user equipment can be handed over to the control of a second controller. The determination of the location of the user equipment controlled by the first controller can continue until the handing over has been completed.

In another embodiment of the present invention a location entity for use in a communications system includes a controller and the location entity can be configured to receive a request for the location of user equipment, and initiate a determination of the location. The location entity can be such that when the user equipment is to be handed over to the control of a second, different controller, the determination of the location of the user equipment controlled by the first controller can continue until the handing over has been completed.

### BRIEF DESCRIPTION OF THE DRAWINGS

For a better understanding of the present invention and to show how the same may be carried into effect, reference will now be made by way of example to the accompanying drawings in which:

FIG. 1 shows one embodiment of the present invention;

FIG. 2 shows a second embodiment of the present invention; and

FIG. 3 shows the flow of messages between the MSC, the BSC and the SMLC in accordance with the main principles of an embodiment of the present invention.

### DETAILED DESCRIPTION OF THE PREFERRED EMBODIMENTS:

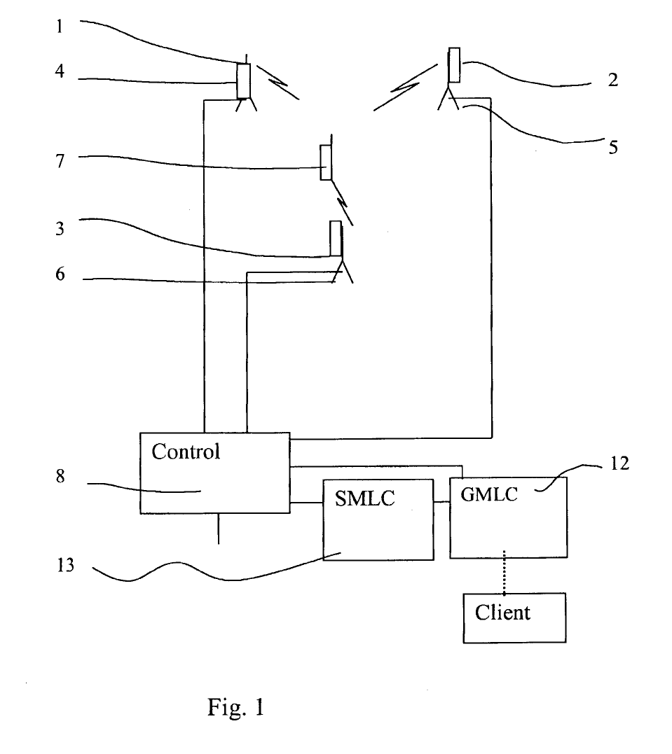

Reference is made to FIG. 1 which is a simplified presentation of some of the components of a cellular system. For example, FIG. 1 shows an arrangement in which three base stations 4, 5 and 6 can provide three radio coverage areas or cells of a cellular telecommunications network.

Each base station 4 to 6 can be configured to transmit signals to and receive signals from the mobile user equipment (UE), for example, a mobile station (MS) 7 via wireless communication. Likewise, the mobile station 7 is able to transmit signals to and receive signals from the base stations. It should be appreciated that a number of mobile stations may be in communication with each base station although only one mobile station 7 is shown in FIG. 1 for clarity.

The cellular systems provide mobility for the users thereof. In other words, the mobile station 7 is able to move from one cell coverage area to another cell coverage area. The location of the mobile station 7 may thus vary in time as the mobile station is free to move from one location (base station coverage area or cell) to another location (to another cell) and also within one cell.

It should be appreciated that the presentation is highly schematic and that in practical implementations the number of base stations would be substantially higher. One cell may include more than one base station site. A base station apparatus or site may also provide more than one cell. These features of a cell depend on the implementation and circumstances.

Each of the base stations 4 to 6 can be controlled by appropriate controller function 8. The controller function may be provided by any appropriate controller. A controller may be provided in each base station or a controller can control a plurality of base stations. Solutions wherein controllers are provided both in individual base stations and in the radio access network level for controlling a plurality of base stations are also known. It should be appreciated that the name, location and number of controller entities depends on the system. For example, a UMTS terrestrial radio access network (UTRAN) may employ a controller node that is referred to as a radio network controller (RNC). In the GSM a corresponding radio network controller entity is referred to a base station controller (BSC). In this document the term base station controller will be used and is intended to include all of these different examples of a controller mentioned in this paragraph.

The core network of both of the above mentioned systems may be provided with controller entities referred to as a mobile switching center (MSC). It is also noted that more than one controller can be provided in a cellular network.

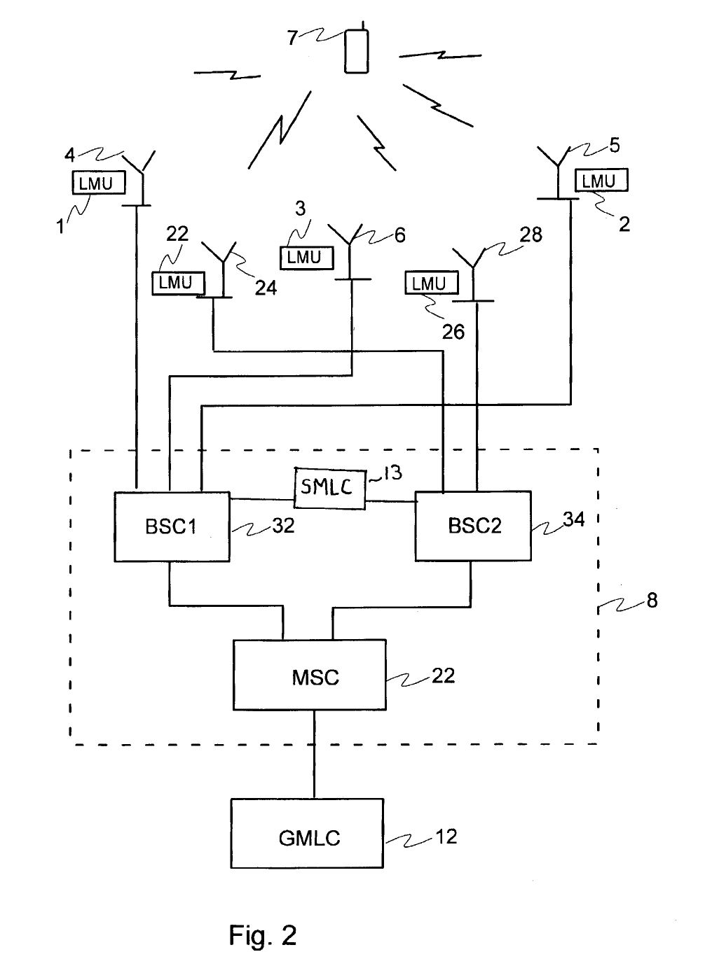

In this specification all such possible controllers are denoted by the controller 8 of FIG. 1. In other words, the controller 8 may include at least two base station controllers and at least one mobile switching center as will be described later in relation to the embodiment shown in FIG. 2. The controller 8 may be connected to other appropriate elements, such as to another mobile switching center (MSC) and/or a serving general packet radio service support node (SGSN), via a suitable interface arrangement. However, as these do not form an essential part of the invention, the various other possible controllers are omitted from FIG. 1 for clarity.

The communication system is also shown to include means for providing a location service. For example, FIG. 1 shows a location services (LCS) node 12 providing location services for different applications or clients. In general terms, a location services node can be defined as an entity capable of providing client applications with information concerning the geographical location of a mobile station. There are different ways to implement the location services node, and the following will discuss an example that employs the so-called gateway mobile location center (GMLC).

The gateway mobile location center (GMLC) 12 can be configured to receive, via appropriate interface means, predefined information concerning the geographical location of the mobile station 7 from the cellular system. In addition to the information associated with the geographical location, the information provided for the node 12 may include the identity (such as an international mobile subscriber identifier: IMSI) or a MSIDSN (a mobile subscriber integrated digital services number) or a temporary identifier of the mobile station 7.

The location information may be provided for the GMLC 12 by means of a serving mobile location center (SMLC) 13. The location service node 13 can be seen as an entity that functions to process location measurement data received from the network in order to determine the geographical location of the mobile station. The location measurement data may be provided by various elements associated with the network such as means of one or several location measurement units 1 to 3 provided in association with at least some of the base stations and/or the mobile station 7. Node 13 can process this measurement data and/or some other predefined parameters and input information and/or and to execute appropriate calculations for determining and outputting information associated with the geographical location of the given mobile station 7. The output information will be referenced below as location estimate.

In other words, the information from the various location measurement means can be processed in a predefined manner by node 13. A location estimate may then be provided to the GMLC 12. Authorized clients can then be served by the GMLC 12.

The serving location service node 13 may be implemented in the radio access network or the core network. If the serving location service node is implemented in the radio access network it may be in direct communication with the access network controller function 8 and the LCS node 12. In some applications the node 13 may be a part of the access network controller function. If the serving location service node is implemented in the core network it may then be configured to receive the location measurement data from the radio network, for example, by the access network control function 8. The way the location service architecture is arranged is an implementation issue, and will thus not be explained in more detail.

As mentioned above, the location information may be given as a location estimate. The location estimate may be defined on the basis of the measurements regarding the position of the mobile station relative to the base station(s). This information may be produced by specific location measurement units 1 to 3 or similar units implemented on the network side and/or at the mobile station 7 itself.

FIG. 2 shows an embodiment of the present invention where the TDOA method is being used and certain of the communications channels which communicate with the mobile station 7 via the base stations 4, 5, 6 are controlled by a first BSC 32, and the other communication channels which communicate with the mobile station 7 via base stations 24 and 24 are controlled by a second BSC 34.

It should be appreciated that for U-TDOA (uplink TDOA) each of the base stations 4, 5, 6, 24, 28 can be equipped with a corresponding LMU (Location Measurement Unit) 1, 2, 3, 22, and 26. It should also be appreciated that the LMUs can be implemented in different ways. That is, in one embodiment the LMUs can be integrated within the base stations 4, 5, 6, 24, 28 or alternatively they could be implemented as stand-alone units. In the case of stand-alone units the communications between the LMUs and the network is preferably also carried out over the air interface, although in an alternative embodiment the measurements may be conveyed to the network over a fixed link. Moreover, the stand-alone units may have separate antennas or share antennas with an existing base station.

The embodiment illustrated in FIG. 2 includes a handover situation, wherein handover is performed from a first communication channel to a second and different communication channel, and wherein the first channel is under the control of the first BSC 32 and the second channel is under the control of the second BSC 34. In an alternative embodiment, the communication channels may be under the control of different MSCs, for example, a first MSC and a second MSC (not shown).

Although the SMLC 13 is shown as being connected to the first and second BSCs 32, 34 in FIG. 2, it is able to receive measurements from the LMUs 1, 2, 3 either over a radio interface or otherwise, and can initiate procedures for processing these measurements so as to determine the location of the mobile station 7. The determined location can then be sent to the GMLC 12 as described before.

An Inter-BSC or inter-MSC handover occurs when communications are handed over from a first channel controlled by a first BSC 32 (or first MSC) to a target channel controlled by a second BSC 34 (or second MSC). However, this situation causes a problem for location procedures. In the past, if an inter-BSC or inter-MSC handover occurred during the TDOA location procedure then the BSC controlling the first channel would send to the SMLS a BSSLAP (Base Station Subsystem Application Part) “abort” message to the SMLS, which will discard the location procedure. If the handover is unsuccessful, the MSC has to restart the location procedure since all earlier measurements on the first channel were discarded. This disadvantage becomes even more apparent in a busy network, in which queuing to handover to a target channel may last over 10 seconds and end due to congestion.

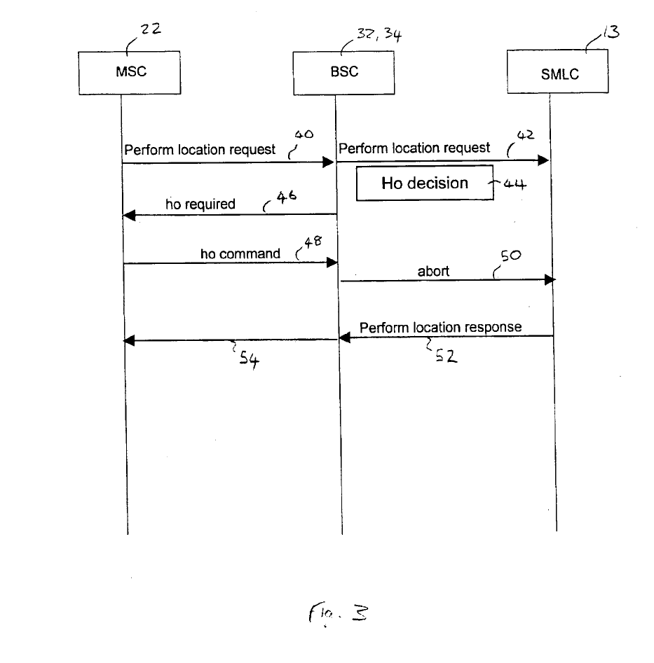

An embodiment of the present invention solves this problem by not sending the abort message until the handover has been completed. In this way, the SMLC will have more time to determine the location of the mobile station and in the case of an unsuccessful handover, the earlier measurements taken of the mobile station communication on the first channel are still valid. FIG. 3 shows in more detail the flow of messages between the MSC 22, the BSC 32, and the SMLC 13 and the states of the system according to a preferred embodiment.

The MSC 22 begins with a request message 40 to the first BSC 32, which controls the channel presently being served. The BSC 32 then relays the request message 42 to the SMLC so that the SMLC begins the TDOA location procedure in relation to the mobile station 7 communicating over a first channel. Then state 44 indicates that the system has decided on making a handover so that the mobile station should now communicate over a second communication channel controlled by the second BSC 34. The first BSC 32 being aware of the handover decision, sends a message 46 to the MSC 22 informing the MSC that a handover to the other BSC is required.

The MSC 22 then sends to the BSC 32 a “ho command” message 48 containing information as to whether or not the handover was successful. If the handover is unsuccessful then the earlier measurements received from communications on the first channel are still valid and the determination of the location is unaffected and can be completed. If on the other hand, the handover is successful then the BSC 32 sends the BSSLAP “abort” message 50 to the SMLC 13 and the location measurements are discarded and need to be initiated again by informing the BSC 32 using message 52 and the MSC 22 using message 54 that a new request for initiating the location of the mobile station 7 on the second communications channel is needed.

That is, the present invention continues the location procedures until the result of the handover is received. If the handover is unsuccessful, then the SMLC has more time to collect measurements and determine the location of the mobile station.

It should be appreciated that while the embodiments have been described in relation to the TDOA method, measurement data for the location service may be obtained by using one or more of the appropriate location determination techniques, for example E-OTD (enhanced Observed time difference), the signal Round Trip Time (RTT), and timing advance (TA) information, signal strength measurements, and so on. The geographical location information may also be based on use of information provided by a location information services system that is independent from the communication system. Examples of these include the Global Positioning System (GPS), Assisted GPS (A-GPS) or the Differential GPS (D-GPS).

It should be appreciated that while embodiments of the present invention have been described in relation to mobile stations, embodiments of the present invention are applicable to any other suitable type of mobile user equipment.

It is also noted herein that while the above describes exemplifying embodiments of the invention, there are several variations and modifications which may be made to the disclosed solution.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method of locating user equipment which is able to communicate over at least a first and a second channel, the method comprising:
requesting a location of user equipment which is communicating on a first channel;
initiating a determination of the location of the user equipment; and
handing over the user equipment to communicate on a second channel,
wherein said determination of the location of the user equipment on the first channel continues until said handing over has been completed.

2. The method according to claim 1, wherein when said handing over is completed then the determination of the location of the user equipment is aborted.

3. The method according to claim 1, wherein when said handing over is determined to be unsuccessful then the determination of the location of the user equipment communicating on the first channel is aborted.

4. The method according to claim 2, wherein the determination of the location of the user equipment is aborted by an abort message in response to a handover command message.

5. The method according to claim 4, wherein the abort message is issued by a first type of controller in response to the handover command message, which is issued by a second type of controller.

6. The method according to claim 5, wherein the issuing of the abort message by the first type of controller is performed by a base station controller and the issuing of the handover command message by the second type of controller is performed by a mobile switching center.

7. The method according to claim 1, further comprising controlling the first and second channels by a corresponding first and second type of controllers.

8. The method according to claim 7, wherein the step of controlling the first and second channels by a corresponding first and second type of controllers comprises controlling the first and second channels by corresponding base station controllers.

9. The method according to claim 7, wherein the step of controlling the first and second channels by a corresponding first and second type of controllers comprises controlling the first and second channels by mobile switching centers.

10. The method according to claim 1, wherein the step of requesting a location of user equipment comprises requesting a location of a mobile station.

11. The method according to claim 1, wherein said determination of the location of the user equipment uses a time difference of arrival technique.

12. A system for locating user equipment which is able to communicate over at least a first and a second channel, the system comprising:
a location entity; and
a first controller configured to send a request to the location entity for a location of user equipment which is communicating on a first channel, the location entity being configured to initiate a determination of the location of said user equipment, wherein when said user equipment is to be handed over to a second channel, the determination of the location of the user equipment on the first channel is continued until said handing over has been completed.

13. The system according to claim 12, wherein the second channel is controlled by a second controller, different from said first controller.

14. The system as claimed in claim 13, wherein the first and second controllers comprise one of base stations and mobile switching centers.

15. The system according to claim 14, wherein the first and second controllers comprise base station controllers that are controlled by a mobile switching center.

16. The system as claimed in claim 12, wherein said location entity is configured to use a time difference of arrival method to determine the location of the user equipment.

17. The system as claimed in claim 12, wherein the first controller is configured to receive notification of handing over of the user equipment.

18. A method of locating user equipment, the method comprising:
requesting a location of user equipment which is controlled by a first controller;
initiating a determination of the location of the user equipment;
handing over the user equipment to control by a second controller; and
wherein said determination of the location of the user equipment controlled by the first controller continues until said handing over has been completed.

19. A location entity for use in a communications system comprising a controller, said location entity being configured to:
receive a request for a location of user equipment, and
initiate a determination of said location,
wherein said location entity is such that when the user equipment is to be handed over to control by a second, different controller, the determination of the location of the user equipment controlled by a first controller is continued until said handing over has been completed.

20. A system of locating user equipment which is able to communicate over at least a first and second channel, the system comprising:
requesting means for requesting a location of user equipment which is communicated on a first channel;
initiating means for initiating a determination of the location of user equipment; and
handing over means for handing over the user equipment to communicate of a second channel,
wherein the determination of the location of user equipment on the first channel continues until the handing over has been completed.

21. The system according to claim 20, wherein when the handing over is completed, then the determination of the location of the user equipment is aborted.

22. The system according to claim 20, wherein when the handing over is determined to be unsuccessful, then the determination of the location of the user equipment communicating on the first channel is aborted.
